(19) United States
(12) Patent Application Publication
(10) Pub. No.: US 2006/0252853 A1
(43) Pub. Date: Nov. 9, 2006

(54) Nanotube polymer composite and methods of making same

(75) Inventors: Pulickel Ajayan, Troy, NY (US); Chang Y. Ryu, Troy, NY (US); Nirupama Chakrapani, Troy, NY (US); Gunaranjan Viswanathan, Troy, NY (US); Seamus Curran, Troy, NY (US)

Correspondence Address: FOLEY AND LARDNER LLP;SUITE 500, 3000 K STREET NW, WASHINGTON, DC, 20007, US

(73) Assignee: RENSSELAER POLYTECHNIC INSTITUTE

(21) Appl. No.: 10/535,279

(22) PCT Filed: Nov. 18, 2003
(86) PCT No.: PCT/US03/36844

§ 371 Date: Jun. 16, 2006

Related U.S. Application Data
(60) Provisional application No. 60/427,097, filed on Nov. 18, 2002.

(51) Int. Cl. D01F 9/12; C08K 9/00

(52) U.S. Cl. 523/215; 423/447.1; 977/847; 524/495

(57) ABSTRACT

The invention relates to derivatized, well-dispersed CNTs that have enhanced miscibility with organic agents. Composite materials may be made using such CNTs. The composite materials, in turn, may be used in optical and electronic applications.

### CROSS-REFERENCE TO RELATED APPLICATIONS

This application claims priority to U.S. Provisional Application Ser. No. 60/427,097, filed Nov. 18, 2002, the disclosure of which is incorporated by reference herein in its entirety.

### FIELD OF THE INVENTION

This invention concerns single and multiwalled carbon nanotube/polymer composites, a process for producing and controlling the morphological aspects of such, and their use as active components for electrical, electronic and/or optical applications.

### BACKGROUND OF THE INVENTION

The discovery of Fullerenes by Harold Kroto of Sussex University in the United Kingdom and Richard Smalley and co-workers at Rice University in the United States stimulated researchers to explore carbon molecular nanostructures further. The field of carbon nanotubes exploded in 1991 when Sumio Iijima of the NEC Laboratory used high-resolution transmission electron microscopy to observe carbon nanotubes.

Carbon nanotubes (CNTs) are self-assembled coaxial cylindrical graphene sheets of sp² hybridized carbon atoms. Because of their unique tubular structure and large aspect ratios (length vs. diameter), they have remarkable mechanical and electronic properties, putting them at the fore as a promising candidate for future nanotechnology.

There are two types of CNTs, multi-walled carbon nanotubes (MWNT) and single-walled carbon nanotubes (SWNT). CNTs are unique nanostructures with remarkable electronic and mechanical properties. Interest from the research community first focused on their exotic electronic properties, since nanotubes can be considered as prototypes for a one-dimensional quantum wire. As other useful properties have been discovered, particularly strength, interest has grown in potential applications. CNTs could be used, for example, in nanometer-sized electronics, to strengthen polymer materials or as the active component in electronic applications.

SWNTs are expected to be very strong and to resist fracture under extension, just as the carbon fibers commonly used in aerospace applications. A SWNT can be elongated by several per cent before it fractures. Unlike carbon fibers, however, SWNTs are remarkably flexible. They can be twisted, flattened and bent into small circles or around sharp bends without breaking. Furthermore, severe distortions to the cross-section of SWNTs do not cause them to break.

Another advantage of CNTs is their behavior under compression. Unlike carbon fibers, which fracture easily under compression, CNTs form kink-like ridges that can relax elastically when the stress is released. As a result, CNTs not only have the desirable properties of carbon fibers, but are also much more flexible and can be compressed without fracture. Such excellent mechanical properties can lead to applications in their own right, or in conjunction with other desirable properties.

The mechanical properties of CNTs make them ideal for manipulating other nanoscale structures. Advances in understanding CNTs can therefore have a major impact on the whole field of nanotechnology. Many of the applications now being considered involve MWNTs, partly because they have been available for longer, and partly because many of these applications do not explicitly depend on the one-dimensional quantum effects found mainly in SWNTs.

Structures based on CNTs offer exciting possibilities for nanometer-scale electronic applications. In the same way that carbon fibers are used in composites to strengthen a structure or to enhance the electrical conductivity of the main constituent, CNTs can be combined with a host polymer (or metal) to tailor their physical properties to specific applications. Since CNTs are so small, they can be used in polymer composites and formed into specific shapes. In addition, they can be incorporated into a low-viscosity composite that can be sprayed onto a surface as a conducting paint or coating.

Because of their various desirable properties (e.g., extremely high Young's modulus, stiffness and flexibility), SWNTs have been widely touted as attractive candidates for use as fillers in composite materials. Treacy et al. Naure 381: 678 (1996); Yakobson et al. J. Phys. Lett. 76: 2511 (1996). Successful applications of such composite systems, however, require well-dispersed nanotubes with good adhesion with the host matrix. Processing of SWNTs is rendered difficult by poor solubility and the exfoliation of nanotube bundles. Moreover, inherently weak nanotube-polymer interactions result in poor interfacial adhesion, which can lead to nanotube aggregation within the matrix.

Though a variety of chemical routes have been investigated to achieve nanotube solubility, most methods either shorten the nanotubes or induce excessive functionalities that disrupt the original structure of the tubes. See for example, Hirsch Angew. Chem. Int. Ed. 41: 1853 (2002) and Liu et al. Science 280: 1253 (1998). Polymer grafting, to improve the nanotube-polymer interface, has mainly been achieved on acid-treated nanotubes. Still, such grafting may result in partial destruction of the tubular framework. See for example Sano et al. Langmuir 17: 5125 (2001).

There is therefore a need for improved methods of producing well-dispersed nanotubes that can be used in a myriad of applications and composites.

### SUMMARY OF THE INVENTION

One aspect of the present invention provides a process for producing derivatized, well-dispersed carbon nanotubes (CNTs), said process comprising reacting an underivatized CNT with an ionizing agent, thereby generating anions on the surface of said underivatized CNT.

### DETAILED DESCRIPTION OF THE PREFERRED EMBODIMENTS

The following describes certain preferred embodiments of the invention. It should be understood that this description is intended merely to be exemplary of the invention.

It is known that negative charges can be introduced on C₆₀ and these carbanions can further be used as anionic initiators. See Ederle and Mathis, Macroniolecules 30: 4262 (1997). Thus, in one embodiment the invention relates to derivatized, well-dispersed CNTs that comprise functional groups that are directly or indirectly attached to the CNT surface, in one step, using an anionic process.

In the context of derivatized, well-dispersed CNTs, “derivatized” and “well-dispersed” have the following meaning. “Well-dispersed” means that the nanotubes are substantially homogeneously distributed (i.e., allowing for a 1 to 20 percent, preferably 1 to 5 percent inhomogeniety in certain regions of the matrix) in the matrix without phase separation. Preferably, a majority of the well dispersed CNTs are not bundled together. Preferably, about 60%, more preferably about 80%, most preferably about 90% of the derivatized, well-dispersed CNTs are not bundled together. “Derivatized” means that the derivatized, well-dispersed CNTs contain functional groups on their surface; contain a polymer attached/grafted directly to the CNT surface; or contain a polymer attached/grafted onto the CNT surface via the functional groups.

As mentioned above, the functional groups may be directly or indirectly attached to the CNT surface. When the functional groups are directly attached to the CNT surface, there is not any sort of spacer between the functional group and the CNT. Thus, when the functional group is a CO₂H group, for example, the carbon atom of the CO₂H group is directly attached to the CNT.

When the functional groups are indirectly attached to the CNT surface, there is a spacer between the functional group and the CNT surface. Thus, for example, when an OH functional group is indirectly attached to the CNT surface, the oxygen atom of the OH group is spaced from the CNT surface by a spacer. An example of a “spacer” in the context of an embodiment of the present invention is a C₁₋₆ alkyl spacer.

The functional groups that are directly or indirectly attached to the surface of the CNTs serve three purposes. First, they help debundle/disperse CNTs by providing steric bulk and/or electrostatic repulsions between functional groups on adjacent CNTs. Second, the functional groups increase the derivatized CNT solubility in organic materials, thus making the derivatized, well-dispersed CNTs amenable to incorporation into a matrix. The derivatized, well-dispersed CNTs can be dissolved in one or more of the components used to make the matrix prior to formation of the matrix. Third, the functional groups provide sites on the CNTs to which polymers may be grafted. When polymers are grafted on to the CNTs using the functional groups, the CNTs are incorporated into the polymer matrix.

The anionic process of one embodiment of the invention involves the use of an ionizing agent. An ionizing agent is any agent which can add to double bonds on the CNT surface thereby generating anions (carbanions) on the surface of the underivatized CNTs. Ionizing agents include, for example, metal organic initiators such as alkyl lithium compounds (salts), fluorenyl-sodium and cumyl-sodium. Radical ionic initiators such as sodium naphthalenide may also be used.

In a preferred embodiment, the CNT is a SWNT, although MWNTs may also be used.

The anionic process for generating derivatized, well-dispersed CNTs does not disrupt the original structure of CNTs. In addition, the process requires no nanotube pretreatment (e.g., treatment with strong acid to debundle the SWNTs). Lastly, the process does not excessively chemically modify the nanotube surface. Such excessive chemical modification of the CNT surface can lead to degradation of the nanotube mechanical strength, and also result in loss of electronic structure. Garg and Sinott, Chem. Phys. Lett. 295: 273 (1998).

In one embodiment, anions that are formed on the surface of underivatized CNTs using the anionic process are subsequently quenched (i.e., protonated) with an alcohol (e.g., methanol or ethanol). The resulting CNTs may be considered to be derivatized by virtue of the fact that the ionizing agent which has added to the CNT double bond is still attached. When the ionizing agent used is an alkyl lithium salt, for example, the derivatized, well-dispersed CNTs are alkyl-derivatized, well-dispersed CNTs. Thus, if sec-butyl lithium is used as the ionizing agent, the CNTs will have sec-butyl groups attached to their surface. In short, the skilled artisan will appreciate that the CNT surface will comprise the ionizing agent attached thereto, even when the resulting anion is subsequently reacted with agents that place functional groups directly or indirectly attached to the CNT surface.

In another embodiment, instead of quenching the anions with an alcohol, the surface of the underivatized CNTs can be derivatized by adding an agent that reacts with the anions on the surface of the underivatized CNTs thereby generating derivatized, well-dispersed CNTs.

In one embodiment, anions that are formed on the surface of underivatized CNTs using the anionic process are subsequently reacted with agents that place functional groups directly or indirectly attached to the CNT surface. Alternatively, polymer anions, such as polystyryl lithium can directly add or attach to the CNT surface, as described below. Non-limiting examples of agents that place functional groups directly or indirectly attached to the CNT surface include CO₂, ethylene oxide and X(alk)NRR′ (where X is Br or Cl, alk is a C₁₋₆ alkyl chain and R and R′, together with the nitrogen to which they are attached, form a 2,2,5,5-tetralkyl-2,5-disilacyclopentane ring).

When CO₂ is used as the agent, CO₂H is the functional group that is directly attached to the CNT surface. When ethylene oxide or X(alk)NRR′ are used, OH and NRR′ groups, respectively, are indirectly attached to the CNT surface by virtue of the fact that an alkyl group separates the OH and the NRR′ groups from the CNT surface. The NRR′ group may be converted to an NH₂ group by methods well known in the art (e.g., 1% HCl solution).

In one embodiment, CO₂H, OH and NH₂ derivatized, well-dispersed CNTs can be used to graft polymers onto the CNT surface. For example, CO₂H groups on the derivatized, well-dispersed CNTs may be used to graft polyamides (e.g., nylons) and polyesters (e.g., poly(ethylene terephtalate), also known as PET) onto the CNT surface. NH₂ groups may be used to graft polyamides onto the CNT surface. OH groups may be used to graft polyesters onto the CNT surface.

In another embodiment, polymers may be directly attached to the CNT surface. The anions produced by the anionic process react with a monomer thereby producing a new anionic species that can react with another monomer, thereby producing a new anionic species. The polymerization of the monomers is thus initiated by the anions produced by the anionic process and progresses until monomers are consumed or until a protonating agent (e.g., an alcohol) is added that quenches any anions thereby halting the polymerization reaction.

Non-limiting examples of monomers that may be used to directly link polymers to CNTs include: vinylic monomers, acrylic monomers and heterocyclic monomers.

Vinylic monomers include, without limitation, styrene, α-methylstyrene, substituted styrenes (e.g., p-methoxy, p-vinyl, p-chloro, p-methyl and p-dimethylamino), dienes (e.g., butadiene, isoprene, piperylene and phenylbutadiene), vinylnaphthalene, vinylpyridine, and the like.

Acrylic monomers include, without limitation, alkyl acrylates (e.g., methyl, ethyl and butyl), acrylonitrile and methacrylonitrile.

Heterocyclic monomers include, without limitation, ethylene oxide, propylene oxide, isobutylene oxide, caprolactone, pyrrolidone, glycolide and ethylene sulfide.

In another embodiment, the carbanions are generated on a polymer, which carbanions are then reacted with CNTs. For example, terminal vinylic carbanions of polymers resulting from the anionic polymerization of vinylic monomers may be reacted with CNTs thereby giving polymer-derivatized, well-dispersed CNTs. In this case, vinyl monomers undergo nucleophilic attack using a base thereby generating vinylic carbanions. Exemplary bases used to form the vinylic carbanions include alkyl lithium salts (e.g., sec-butyl lithium, n-butyl lithium, or the like). The vinylic carbanions then polymerize thereby generating a terminal vinylic carbanion. The terminal vinylic anion, in turn, is then reacted with CNTs. Following quenching of the anions generated by this reaction, polymer-derivatized, well-dispersed CNTs are obtained. It should be noted that, in this case, the terminal vinylic carbanions are behaving as ionizing agents.

The derivatized, well-dispersed CNTs of the embodiments of the invention are highly soluble in organic materials. Their increased solubility make them ideal for the production of composite materials where the derivatized, well-dispersed CNTs are incorporated into a matrix formed by such organic materials (e.g., polymer matrix materials).

In one embodiment, the derivatized, well-dispersed CNTs are dissolved in an organic material from which a matrix may be formed. As the matrix forms, the CNTs are incorporated into the matrix. The matrix that is formed may be the same or different relative to any polymer that may already be attached to the derivatized, well-dispersed CNTs. For example, the derivatized, well-dispersed CNTs may have polyesters attached to their surface via an alcohol or amine functional group. The matrix into which such a polyester-derivatized, well-dispersed CNTs is incorporated need not be a polyester matrix; instead it may be a polyamide matrix or a polycarbonate matrix, for example.

Matrices that are contemplated by an embodiment of the invention include, without limitation, a polyamide, polyester, polyurethane, polysulfonamide, polycarbonate, polyurea, polyphosphonoamide, polyarylate, polyimide, poly(amic ester), poly(ester amide), a poly(enaryloxynitrile) matrix or mixtures thereof.

In another embodiment, the derivatized, well-dispersed CNTs are incorporated into a sulfur containing polymer matrix (e.g., aromatic polydithiocarbonate and polythiocarbonate) or a liquid crystalline(LC) thermotropic main-chain polyester and copolyester matrix.

In still another embodiment, the derivatized, well-dispersed CNTs are incorporated into a matrix of a poly(ester amide)s related to nylons and polyesters 6,10 or 12,10. For example, poly(ester amide)s may comprises copolymers, such as poly(butylene adipate)-co-(amino caproate).

In yet another embodiment, the derivatized, well-dispersed CNTs are incorporated into a matrix of aromatic-aliphatic poly(enaminonitriles) (PEANs), cross-linked polyamide or polyester network structures, fluorine-containing, methylene-bridged aromatic polyesters or blue luminescent polyethers. This may be accomplished by dissolving the derivatized CNTs in one monomer and then incorporating into the matrix by polymerization.

In still another embodiment, the derivatized, well-dispersed CNTs are incorporated into a matrix of the following polymers or mixed polymers: polycarbonate/polybutylene terphthalate (PC/PBT), polycarbonate/polyethylene terephthalate (PC/PET), polyamide (PA) reinforced with modified polyphenylene ether (PPE), polyphenylene suphide (PPS), polybutylene terephthalate (PBT), polyethylene terephthalate (PET), polyetherimide, expandable polystyrene poly(2,6-dimethyl-1,4-phenylene ether (PPE), modified polyphenylene ether (PPE), polycarbonate (PC), acrylic-styrene-acrylonitrile (ASA), polycarbonate/acrylonitrile-butadiene-styrene (PC/AILS) and acrylonitrile-butadiene-styrene (ABS), or mixtures thereof.

In yet another embodiment, composite materials comprising derivatized, well-dispersed CNTs are used as an electron carrying device for use in band-bending architecture. Examples of such band-bending architectures include devices such as light emitting diodes (LEDs), liquid crystalline displays (LCDs), photovoltaic devices, Schottky Junction devices and solar cells.

In another embodiment, composite materials comprising derivatized, well-dispersed CNTs are used in the production of pseudo-low work function electrical contacts for electron transport in devices such as LEDs, LCDs, photovoltaic devices, Schottky Junction devices and solar cells.

In yet other embodiments, the composite materials comprising derivatized, well-dispersed CNTs are used in electro-optic applications, in an electron emission gun, in a photovoltaic device, in other electronic devices, such as plasma displays, in a nanoelectronic device, in a gas, radiation or thermal sensor, in an antistatic material, as the active electronic material in a device architecture, as the active component in temperature/pressure responsive materials, as the active component in bioactive applications, as the active component in engineering resins, as a thermal conductor, as a thermal insulator, as a composite synthetic thread, as a composite web, as a composite pellet or as a composite thin film (1 mm to 10 cm thick). The alignment of well dispersed nanotubes in the polymer matrix may be used as a factor in morphological design and applications.

Having now generally described this invention, the same will be understood by reference to the following examples which are provided herein for purposes of illustration only, and are not intended to be limiting unless otherwise specified.

### EXAMPLE 1

### SWNTs in General

HiPCO SWNTs were obtained from Carbon Nanotechnologies Inc. (Houston, USA). The tubes have an average length around 1 μm and the predominant impurities are iron catalyst particles (5-6 at. %). To ensure that the nanotubes are free of air and absorbed moisture prior to derivatization, they were dried under dynamic vacuum (10⁻³ torr) at 200° C. for 12 hours and subsequently stored under argon. SWNTs produced by the HiPCO process, were used without further purification, as purification procedures might introduce functionalities that hinder carbanion formation. Nikolaev et al. Chem. Phys. Lett. 313: 91 (1999).

### EXAMPLE 2

### Grafting Alkyl Groups

An alkyllithium, R(−)Li(+) (e.g. sec-butyl lithium) is reacted with dried SWNTs to induce the formation of carbanions in the carbon nanotubes and thereby grafting the alkyl groups onto the SWNT surface. Degassed protic alcohol, such as methanol and/or buthanol, is then added to quench the carbanions on the SWNT by protonation. During this process, the SWNTs are well-dispersed/debundled due to the electrostatic repulsion between negatively charged SWNTs during the reaction. Since bundling of SWNT no longer exists, the reaction solution remain homogenous.

### EXAMPLE 3

### Introduction of Functional Groups

Introducing NH₂ Groups

An alkyllithium, R(−)Li(+) (e.g. sec-butyl lithium) is reacted with dried SWNTs to induce the formation of anions on the SWNT surface. The SWNTs comprising anions are then reacted with 1-(3-bromopropyl)-2,2,5,5-tetramethyl-1-aza-2,5-disilacyclopentane to graft the protected amine functional groups. The reaction mixture is then treated with a degassed, protic alcohol such that any remaining anions are quenched in a controlled manner. The protected amine groups are then hydrolyzed by refluxing in 1% HC1 solution. The NH₂-derivatized, well-dispersed SWNTs are then dried.

Introducing COOH Groups

An alkyllithium, R(−)Li(+) (e.g. sec-butyl lithium) is reacted with dried SWNTs to induce the formation of anions on the SWNT surface. The SWNTs comprising anions are then reacted with dry and oxygen free carbon dioxide gas. The reaction mixture is then treated with a degassed, protic alcohol such that any remaining anions are quenched in a controlled manner. The CO₂H-derivatized, well-dispersed SWNTs are then dried.

Introducing OH Groups

An alkyllithium, R(−)Li(+) (e.g. sec-butyl lithium) is reacted with dried SWNTs to induce the formation of anions on the SWNT surface. The SWNTs comprising anions are then reacted with dry and oxygen free ethylene oxide gas. The reaction mixture is then treated with a degassed, protic alcohol such that any remaining anions are quenched in a controlled manner. The OH-derivatized, well-dispersed SWNTs are then dried.

### EXAMPLE 4

### Grafting Vinyl Polymers by Anionic Polymerization

Grafting of Vinyl Polymers

An alkyllithium, R(−)Li(+) (e.g. sec-butyl lithium) is reacted with dried SWNTs to induce the formation of anions on the SWNT surface. The SWNTs comprising anions are then reacted with vinyl monomers to initiate anionic polymerization. The reaction mixture is then treated with a degassed, protic alcohol such that any remaining anions are quenched in a controlled manner. The polymer-derivatized, well-dispersed SWNTs are then precipitated using methanol. The product is a mixture of polymer-derivatized SWNT and homopolymers. In other words, the polymer-derivatized SWNTs have been incorporated into a homopolymer matrix. The homopolymers, naturally, result from the reaction of excess alkyllithium and vinyl monomer. If necessary, separation of polymer-derivatized SWNTs and homopolymers could be easily done by filtering toluene solutions (which dissolve the homopolymers) of those mixtures through 0.2 micron Teflon membrane filter.

Grafting of Styrene

Styrene monomer (Acros Organics) was purified by prepolymerization with dibutylmagnesium (1 M solution in heptane, Aldrich) for 2 hours, degassed and collected by vacuum distillation. Cyclohexane (99.8%, Fisher Scientific) was purified by stirring in concentrated sulfuric acid for 2 days followed by refluxing under polystyryl anions. The solvent was degassed prior to use. Both pure monomer and solvent were stored in argon until further use. Sec-butyllithium (1.3 M solution in cyclohexane/hexane (92/8), Acros Organics) was used as received.

For all experiments, the amount of styrene used was 10 mL. The amount of initiator (sec-butyllithium) varied depending on the molecular weight of polystyrene desired. For example, to obtain a molecular weight of 20,000 g mol⁻¹, 10 mL of purified styrene monomer and 0.5 mL of sec-butyllithium was used, thereby generating the styryl anion at the terminal vinyl carbon. The styryl anion then polymerizes to give a terminal polystyryl anion. The terminal polystyryl anion is then reacted with the SWNTs. After quenching of the resulting anion on the surface of the styrene-derivatized SWNTs, the polystyrene-grafted nanotubes were separated from the polymer matrix by washing with toluene and vacuum filtration through a 0.2 μm Teflon membrane. After repeated washing and filtration steps, the nanotubes were dried in vacuum overnight. To ensure complete removal of any absorbed polystyrene, the dried nanotubes were re-dispersed in toluene, and the washing and filtration steps were repeated. The final product, free from ungrafted polystyrene and containing polystyrene-grafted SWNTs, was dried overnight in vacuum.

### EXAMPLE 5

### Grafting Vinyl Polymers Using Polymeric Anions

An alkyllithium, R(−)Li(+) (e.g. sec-butyl lithium) is reacted with a purified vinyl monomers. The resulting polymeric anion is reacted with dried SWNTs thereby producing polymer-derivatized, well dispersed SWNTs. The reaction mixture is then treated with a degassed, protic alcohol such that any remaining anions are quenched in a controlled manner. The polymer-derivatized, well-dispersed SWNTs are then precipitated using methanol. The product is a mixture of polymer-derivatized SWNT and homopolymers. In other words, the polymer-derivatized SWNTs have been incorporated into a homopolymer matrix. The homopolymers, naturally, result from the reaction of excess alkyllithium and vinyl monomer. If necessary, separation of polymer-derivatized SWNTs and homopolymers could be easily done by filtering toluene solutions of those mixtures through 0.2 micron Teflon membrane filter.

### EXAMPLE 6

### Incorporation of Derivatized, Well-dispersed SWNTs Into A Polymer Matrix

The derivatized well-dispersed nanotubes can be incorporated into a variety of polymer matrices, either by mixing pre-formed polymers with the derivatized, soluble CNTs in a common solvent or by dissolving the derivatized CNTs in the monomer and subsequent polymerization. In the former method, for example, polystyrene-grafted CNTs are dissolved in toluene, along with a preformed polymer such as poly(methyl methacrylate). The dispersion is then precipated using an antisolvent such as methanol to yield well-dispersed CNT-containing composites. Alternatively, the derivatized CNTs are dissolved in a monomer and subsequent polymerization, such as interfacial or suspension polymerization, is carried out to incorporate the CNTs in the matrix. For example, for a nylon matrix, the process would be as follows. The derivatized CNTs are dissolved in an organic phase containing dicarboxylic acid chloride, and diamine is dissolved in water. The two non-miscible liquid layers are superposed to yield a polyamide-CNT composite at the interface, which is constantly pulled out (i.e., interfacial polymerization).

From the foregoing description, one skilled in the art can easily ascertain the essential characteristics of this invention, and without departing from the spirit and scope thereof, can make various changes and modifications of the invention to adapt it to various usages and conditions without undue experimentation. All patents, patent applications and publications cited herein are incorporated by reference in their entirety.

1. A process for producing derivatized, well-dispersed carbon nanotubes (CNTs), said process comprising reacting an underivatized CNTs with an ionizing agent, thereby generating anions on the surface of said underivatized CNTs.

2. The process of claim 1, wherein said CNT is a SWNT.

3. The process of claim 1, wherein said CNT is a MWNT.

4. The process of claim 1, wherein said ionizing agent is an alkyllithium salt.

5. The process of claim 4, wherein said alkyllithium salt is sec-butyllithium.

6. The process of claim 1, further comprising quenching said anions with an alcohol, thus producing alkyl-derivatized, well-dispersed CNTs.

7. The process of claim 1, further comprising reacting said anions on the surface of said CNTs with an agent that places functional groups attached to the CNTs, thus producing derivatized, well-dispersed CNTs comprising functional groups that are attached to the CNTs.

8. The process of claim 7, further comprising grafting a polymer onto the CNT surface via a functional group.

9. The process of claim 1, further comprising incorporating said derivatized, well-dispersed CNTs into a matrix.

10. The process of claim 8, wherein said matrix is the same as the polymer grafted to said derivatized, well-dispersed CNTs.

11. The process of claim 10, wherein said matrix is different than the polymer grafted to said derivatized, well-dispersed CNTs.

12. The process of claim 9, wherein said matrix is a polyamide, polyester, polyurethane, polysulfonamide, polycarbonate, polyurea, polyphosphonoamide, polyarylate, polyimide, poly(amic ester), poly(ester amide), a poly(enaryloxynitrile) matrix or mixtures thereof.

13. The process of claim 9, wherein said matrix is a sulfur containing polymer matrix or a liquid crystalline(LC) thermotropic main-chain polyester and copolyester matrix.

14. The process of claim 13, wherein said sulfur containing polymer matrix is an aromatic polydithiocarbonate matrix or a polythiocarbonate matrix.

15. The process of claim 9, wherein said matrix is a matrix of a poly(ester amide)s related to nylons and polyesters.

16. The process of claim 15, wherein said polyester is a 6,10 or a 12,10 polyester.

17. The process of claim 15, wherein said nylon is a 6,10 or a 12,10 nylon.

18. The process of claim 9, wherein said matrix is a matrix of aromatic-aliphatic poly(enaminonitriles) (PEANs), cross-linked polyamide network, cross-linked polyester network, fluorine-containing, methylene-bridged aromatic polyesters or a blue luminescent polyethers.

19. The process of claim 9, wherein said matrix is a matrix of polycarbonate/polybutylene terphthalate (PC/PBT), polycarbonate/polyethylene terephthalate (PC/PET), polyamide (PA) reinforced with modified polyphenylene ether (PPE), polyphenylene suphide (PPS), polybutylene terephthalate (PBT), polyethylene terephthalate (PET), polyetherimide, expandable polystyrene poly(2,6-dimethyl-1,4-phenylene ether (PPE), modified polyphenylene ether (PPE), polycarbonate (PC), acrylic-styrene-acrylonitrile (ASA), polycarbonate/acrylonitrile-butadiene-styrene (PC/AILS) or acrylonitrile-butadiene-styrene (ABS).

20. The process of claim 7, wherein said functional groups are directly attached to the CNT surface.

21. The process of claim 7, wherein said functional groups are indirectly attached to the CNT surface.

22. The process of claim 7, wherein said functional groups are selected from the group consisting of CO₂H, OH and NH₂.

23. The process of claim 7, wherein said agent that places functional groups attached to the CNT surface is selected from the group consisting of CO₂, ethylene oxide and X(alk)NRR′, where X is Br or Cl, alk is a C₁₋₆ alkyl chain and R and R′, together with the nitrogen to which they are attached, form a 2,2,5,5-tetralkyl-2,5-disilacyclopentane ring.

24. The process of claim 8, wherein said polymer is a polyamide, polyester, polyurethane, polysulfonamide, polycarbonate, polyurea, polyphosphonoamide, polyarylate, polyimide, poly(amic ester), poly(ester amide), a poly(enaryloxynitrile) or mixtures thereof.

25. A process for producing derivatized, well-dispersed carbon nanotubes (CNTs) comprising functional groups that are attached to the CNT surface, said process comprising:
(a) reacting underivatized CNTs with an ionizing agent thereby generating anions on the surface of the underivatized CNTs; and
(b) reacting said anions on the surface of said CNTs with agents that place functional groups attached to the CNT surface.

26. The process of claim 25, wherein said ionizing agent is sec-butyllithium and said CNTs are SWNTs.

27. The process of claim 25, wherein said agent that places functional groups attached to the CNT surface is selected from the group consisting of CO₂, ethylene oxide and X(alk)NRR′, where X is Br or Cl, alk is a C₁₋₆ alkyl chain and R and R′, together with the nitrogen to which they are attached, form a 2,2,5,5-tetralkyl-2,5-disilacyclopentane ring.

28. The process of claim 25, wherein said functional groups are directly attached to the CNT surface and said functional groups comprise COOH.

29. The process of claim 25, wherein said functional groups are indirectly attached to the CNT surface and wherein said functional groups are selected from the group consisting of OH and NH₂.

30. The process of claims 25, further comprising incorporating said derivatized, well-dispersed CNTs into a matrix.

31. A process for producing derivatized, well-dispersed carbon nanotubes (CNTs) comprising functional groups that are attached to the CNT surface, said process comprising:
(a) reacting underivatized CNTs with an ionizing agent thereby generating anions on the surface of the underivatized CNTs;
(b) reacting said anions on the surface of said CNTs with agents that place functional groups attached to the CNT surface; and
(c) grafting first polymer onto the CNT surface via said functional groups.

32. The process of claim 31, wherein said ionizing agent is sec-butyllithium and said CNTs are SWNTs.

33. The process of claim 31, wherein said agent that places functional groups attached to the CNT surface is selected from the group consisting of CO₂, ethylene oxide and X(alk)NRR′, where X is Br or Cl, alk is a C₁₋₆ alkyl chain and R and R′, together with the nitrogen to which they are attached, form a 2,2,5,5-tetralkyl-2,5-disilacyclopentane ring.

34. The process of claim 31, wherein said first polymer is a polyamide, polyester, polyurethane, polysulfonamide, polycarbonate, polyurea, polyphosphonoamide, polyarylate, polyimide, poly(amic ester), poly(ester amide), a poly(enaryloxynitrile) or mixtures thereof.

35. The process of claim 31, wherein said functional groups are directly attached to the CNT surface and said functional groups comprise COOH.

36. The process of claim 31, wherein said functional groups are indirectly attached to the CNT surface and wherein said functional groups are selected from the group consisting of OH and NH₂.

37. The process of claims 31, further comprising incorporating said derivatized, well-dispersed CNTs into a matrix or wherein the first polymer forms a matrix of a composite polymer-CNT material.

38. A process for producing polymer-derivatized, well dispersed carbon nanotubes (CNTs) comprising:
(a) reacting polymer anions with underivatized CNTs thereby generating anions on the surface of the CNTs; and
(b) quenching said anions with an alcohol, thus producing first polymer-derivatized, well-dispersed CNTs.

39. The process of claim 38, further comprising incorporating said polymer-derivatized CNTs into a second polymer matrix different from the first polymer.

40. The process of claim 38, wherein the first polymer forms a matrix of a composite polymer-CNT material.

41. A process for producing polymer-derivatized, well-dispersed, carbon nanotubes (CNTs) comprising:
(a) reacting underivatized CNTs with an ionizing agent thereby generating anions on the surface of the underivatized CNTs;
(b) reacting said anions on the surface of said CNTs with a first polymer thereby grafting the first polymer onto the CNTs.

42. The process of claim 41, wherein the step of reacting with a polymer comprises reacting the CNTs with a monomer thereby polymerizing the monomer to form a first polymer grafted to the CNT surface.

43. The process of claim 41, wherein the first polymer comprises a vinyl polymer.

44. The process of claim 41, further comprising incorporating said polymer-derivatized CNTs into a second polymer matrix different from the first polymer.

45. The process of claim 41, wherein the first polymer forms a matrix of a composite polymer-CNT material.

46. A composite material comprising derivatized, well-dispersed CNTs, wherein said CNTs are well-dispersed in a polymer matrix; and wherein said CNTs comprises at least one of functional groups on their surface, a polymer grafted directly to the CNT surface, or a polymer grafted onto the CNT surface via the functional groups.

47. The composite material of claim 46, wherein the composite material is incorporated an article selected from the group consisting of light emitting diode (LED), liquid crystal displays (LCD), photovoltaic device, Schottky Junction device solar cell, a pseudo-low work function electrical contact in an electron transport device, an electro-optic device, an electron emission gun, a photovoltaic device, a nanoelectronic device, a gas, radiation or thermal sensor, an antistatic material, an active electronic material in a device architecture, the active component in temperature/pressure responsive material, the active component in bioactive article, the active component in engineering resin, a thermal conductor, a thermal insulator, a thread, a web, a pellet or a thin film.

48. The composite material of claim 46, wherein the composite material is made by the process of claim 25.
